(19) United States
(12) Patent Application Publication
(10) Pub. No.: US 2014/0321770 A1
(43) Pub. Date: Oct. 30, 2014

(54) SYSTEM, METHOD, AND COMPUTER PROGRAM PRODUCT FOR GENERATING AN IMAGE THUMBNAIL

(71) Applicant: NVIDIA CORPORATION, Santa Clara, CA (US)

(72) Inventor: Mandar Anil Potdar, Pune (IN)

(73) Assignee: NVIDIA Corporation, Santa Clara, CA (US)

(21) Appl. No.: 13/869,889

(22) Filed: Apr. 24, 2013

(51) Int. Cl. G06T 11/60

(52) U.S. Cl. CPC G06T 11/60; G06T 2210/22; G06T 2207/30201
USPC 382/282

(57) ABSTRACT

A system, method, and computer program product are provided for generating an image thumbnail. In operation, an image is received. Additionally, a most relevant portion of the image is determined. Further, a cropping area is identified, based on the most relevant portion of the image. The cropping area is applied to the image. Moreover, an image thumbnail for the image is generated, based on the applied cropping area.

### FIELD OF THE INVENTION

The present invention relates to generating image thumbnails, and more particularly to generating image thumbnails by cropping images.

### BACKGROUND

Thumbnails of images are used for displaying multiple images on a screen for applications on phones, tablets, and computers, and also on web pages. The size of thumbnails is generally small to allow for display of many images on single screen. Application designers adopt different approaches to maximize the usability and experience of these small thumbnails. However, current approaches fail to consider relevant portions of the image when generating thumbnails. There is thus a need for addressing these and/or other issues associated with the prior art.

### SUMMARY

A system, method, and computer program product are provided for generating an image thumbnail. In operation, an image is received. Additionally, a most relevant portion of the image is determined. Further, a cropping area is identified, based on the most relevant portion of the image. The cropping area is applied to the image. Moreover, an image thumbnail for the image is generated, based on the applied cropping area.

### BRIEF DESCRIPTION OF THE DRAWINGS

FIG. 1 shows a method for generating an image thumbnail, in accordance with one embodiment.

FIG. 2 shows a method for generating an image thumbnail, in accordance with another embodiment.

FIG. 3 shows a method for generating an image thumbnail, in accordance with another embodiment.

FIG. 4 shows a method for generating an image thumbnail, in accordance with another embodiment.

FIG. 5 shows a relevant portion determination of images, for use in generating an image thumbnail, in accordance with one embodiment.

FIG. 6A shows an image with a rectangular crop applied to the center of Image A and Image B of FIG. 5.

FIG. 6B shows an image with a center crop of Image A and Image C of FIG. 5.

FIG. 6C shows an image with a square center crop of Image C of FIG. 5.

FIGS. 7A-7C illustrate exemplary results of applying the cropping rectangle to the images of FIG. 5, in accordance with one embodiment.

FIG. 8 illustrates an exemplary system in which the various architecture and/or functionality of the various previous embodiments may be implemented.

### DETAILED DESCRIPTION

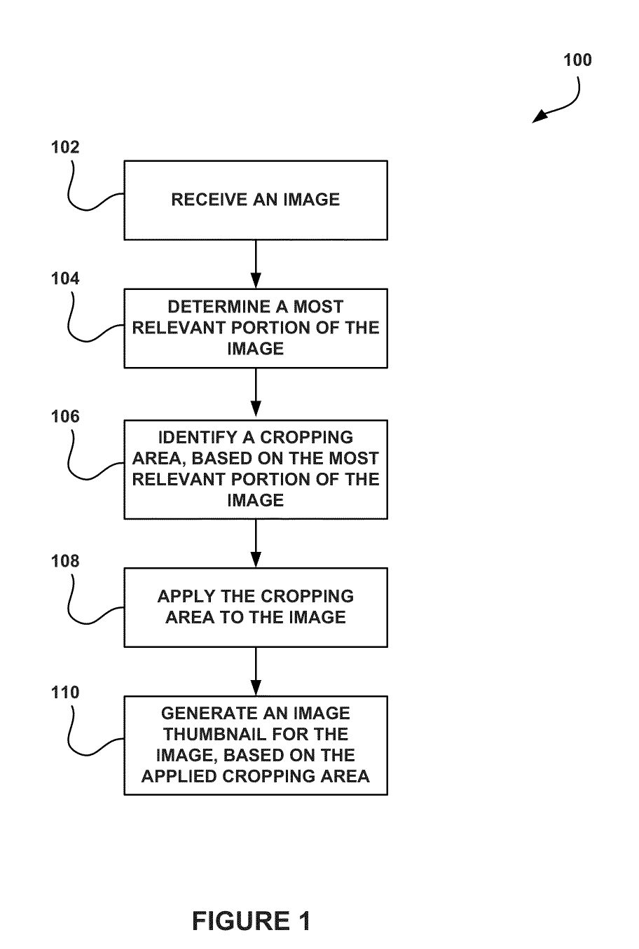

FIG. 1 shows a method 100 for generating an image thumbnail, in accordance with one embodiment.

As shown, an image is received. See operation 102. Additionally, a most relevant portion of the image is determined. See operation 104. Further, a cropping area is identified, based on the most relevant portion of the image. See operation 106.

The cropping area is applied to the image. See operation 108. Moreover, an image thumbnail for the image is generated, based on the applied cropping area. See operation 110.

In the context of the present description, a thumbnail refers to any reduced-sized version of an original image that is capable of being utilized to recognize and/or organize the original image (e.g. serving the same role for images as a normal text index does for words, etc.). For example, in one embodiment, the thumbnail may include a cropped version of an image.

In the context of the present description, cropping refers to any technique capable of being utilized to remove outer data of an image to improve framing, accentuate subject matter, and/or change an aspect ratio. In one embodiment, cropping may include removing data outside of a cropping area. For example, in various embodiments, the cropping area may include a rectangular area, a square area, or a circular area, etc., that covers a relevant portion of an image. In this case, the area outside of the cropping area may be cropped, such that the relevant portion of the image remains. In one embodiment, the remaining portion of the image may be utilized as the image thumbnail.

Further, in the context of the present description a most relevant portion of the image refers to a portion of the image that is determined to be of interest and/or determined to be a main focus of the image. For example, in various embodiments, the most relevant portion of the image may include a face associated with a person, an object, an animal, areas around such items, and/or any other item of interest in the image.

Accordingly, in one embodiment, determining the most relevant portion of the image may include identifying one or more faces present in the image. In one embodiment, faces in the image may be identified utilizing one or more facial detection algorithms. In some cases, images may include one face associated with one person or multiple faces associated with multiple people.

Thus, in one embodiment, a number of faces present in the image may be determined. In this case, in one embodiment, if it is determined that the number of the faces present in the image is greater than one, a most relevant face in the image may be determined. In various embodiments, the most relevant face in an image may include the largest face in an image (e.g. relative to other faces in the image, etc.), a face located closest to a center point of the image, a face that takes up the most surface area of the image (e.g. a face that was more directly aligned with a camera capturing the image, etc.), a combination of these qualities, and/or any other face that is determined to be the most relevant in the image.

Accordingly, in one embodiment, determining the most relevant face in the image may include determining a largest sized face in the image. In another embodiment, determining the most relevant face in the image may include determining a centric face in the image. In another embodiment, if it is determined that the number of the faces present in the image is greater than one, a relevant region that includes multiple faces may be determined.

Further, the cropping area may be identified based on any aspect of the most relevant portion of the image. In the context of the present description, a cropping area refers to any defined area outside of which data is to be cropped. In various embodiments, the cropping area may include a rectangular area, a square area, or a circular area, etc. In one embodiment, the cropping area may be defined to include the most relevant portion. In this case, the area outside of the cropping area may be cropped, such that the most relevant portion of the image remains. In one embodiment, the remaining portion of the image may be utilized as the image thumbnail.

As an example, in one embodiment, a size of the one or more faces present in the image may be determined. In this case, in one embodiment, the cropping area may be identified based on the size of the one or more faces present in the image. For example, a face may be identified in the image, the size of the face may be determined, a most relevant portion of the image may be determined based on the size of the face (e.g. to include the face, to include the face and an area around the face, etc.), and the cropping area may be identified to include the most relevant portion (e.g. and a perimeter around the most relevant portion, in one embodiment, etc.).

Similarly, in one embodiment, a location of the one or more faces present in the image may be determined. In this case, in one embodiment, the cropping area may be identified based on the location of the one or more faces present in the image. For example, a face may be identified in the image, the location of the face may be determined, a most relevant portion of the image may be determined based on the location of the face (e.g. to include the face, to include the face and an area around the face, etc.), and the cropping area may be identified to include the most relevant portion (e.g. and a perimeter around the most relevant portion, in one embodiment, etc.). Of course, in one embodiment, the cropping area may be identified based on the size and the location of the one or more faces present in the image.

Still yet, the cropping area may be identified as a region including the relevant portion of the image and biased towards a center point of the image. Further, in one embodiment, applying the cropping area to the image may include applying the cropping area centered on the determined most relevant portion of the image. In this case, the area outside the cropping area may be cropped and the remaining portion may be utilized to generate the image thumbnail. In another embodiment, applying the cropping area to the image may include applying the cropping area offset from a center of the determined most relevant portion of the image. For example, a most relevant portion of the image may be determined. Further, a center point of the most relevant portion may be determined. In this case, in one embodiment, the cropping area may be determined to be offset from the determined center point of the relevant portion (e.g. offset towards a center of the image, etc.).

In one embodiment, the method 100 may be viewed as a new technique for deciding a cropping rectangle. For example, in one embodiment, an image may be received, a cropping rectangle may be decided (e.g. based on a determined relevant portion of the image, etc.), the cropping rectangle may be applied, the copped image may be scaled, and a thumbnail may be generated from the scaled cropped image.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

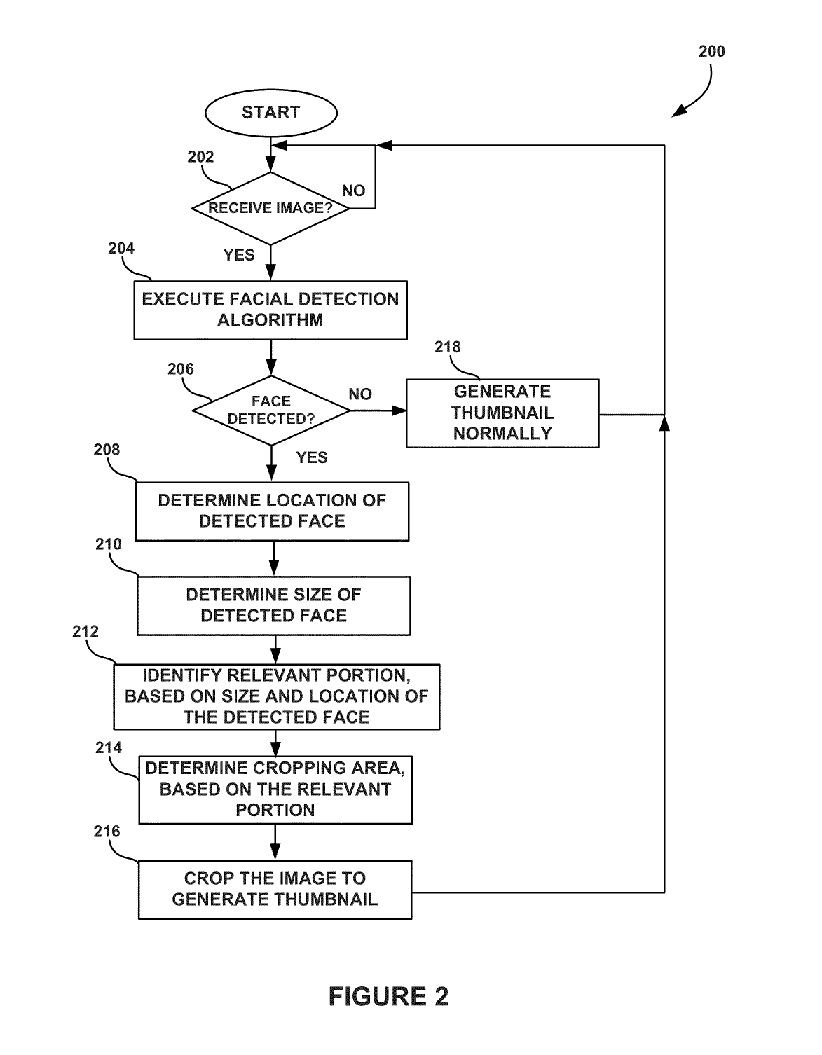

FIG. 2 shows a method 200 for generating an image thumbnail, in accordance with another embodiment. As an option, the method 200 may be implemented in the context of the functionality of the previous Figure and/or any subsequent Figure(s). Of course, however, the method 200 may be carried out in any desired environment. It should also be noted that the aforementioned definitions may apply during the present description.

As shown, it is determined whether an image is received. See decision 202. In one embodiment, the image may be received by an apparatus that is associated with capturing the image. For example, in various embodiments, the image may be received by a camera, a mobile phone, a handheld device, a gaming device, a tablet, a PDA, a computer, a television, components thereof, and/or any other device. In another embodiment, the image may be received by an apparatus that is associated with receiving the image as a message (e.g. an MMS message, an email, etc.) or a download, etc.

If it is determined that an image has been received, a facial detection algorithm is executed. See operation 204. In the context of the present description, a facial detection algorithm refers to any algorithm capable of being utilized to detect the presence of one or more faces in an image. In one embodiment, the facial detection algorithm may be part of a facial recognition software module.

Further, it is determined whether a face is detected in the image. See operation 206. If a face is not detected in the image, a thumbnail of the image is generated in a standard manner. See operation 218. In various embodiments, generating a thumbnail in a standard manner may include cropping the image based on a center point of the image, cropping a top or bottom of the image, or cropping one or both sides of the image, etc.

If a face is detected in the image, a location of the detected face is determined. See operation 208. Additionally, a size of the detected face is determined. See operation 210. In various embodiments, the location and/or size of the face may be determined in coordinate space (e.g. [x,y] coordinate space, etc.) or pixel space, etc.

Based on the determined size and location of the detected face, a relevant portion of the image is identified. See operation 212. In one embodiment, the relevant portion of the image may include the face. In another embodiment, the relevant portion of the image may include the face and an area around the face (e.g. a border, a perimeter, etc.).

Further, a cropping area (e.g. a cropping rectangle, a cropping square, etc.) is determined based on the relevant portion. See operation 214. In one embodiment, the cropping area may include an area that includes the relevant portion (e.g. the face, etc.) and an area around the relevant portion. For example, in one embodiment, the relevant portion may include a square or rectangular area around the face (e.g. so the face is at the extent of the square/rectangle, etc.) and the cropping area may be determined to be a square or rectangular area around the relevant portion.

In one embodiment, the cropping area may be a scaled version of the relevant portion. For example, in one embodiment, the relevant portion may include a square or rectangle that is X units wide and Y units long (where Y may be equal to or greater than X, etc.). In this case, as an example, the cropping area may be determined to be a square or rectangle that is 3X units wide and 3Y units long (e.g. centered over the relevant portion, offset over the relevant portion, etc.). Of course, in various embodiments, the relevant portion and the cropping area may be any shape and/or size (e.g. 4X units wide and 4Y units long, etc.).

Once the cropping area is determined, the image is cropped based on the cropping area and an image thumbnail is generated for the image. See operation 216. In this case, the area of the image outside of the cropping area is cropped and the area inside the cropping area, including the relevant portion, is used as the thumbnail.

In one embodiment, the method 200 may be implemented when the image is captured by a device (or component thereof). In another embodiment, the method 200 may be implemented when the image is saved by a device (or component thereof). In another embodiment, the method 200 may be implemented when the image is received by a device (or component thereof). Further, in one embodiment, the method 200 may be implemented once per image.

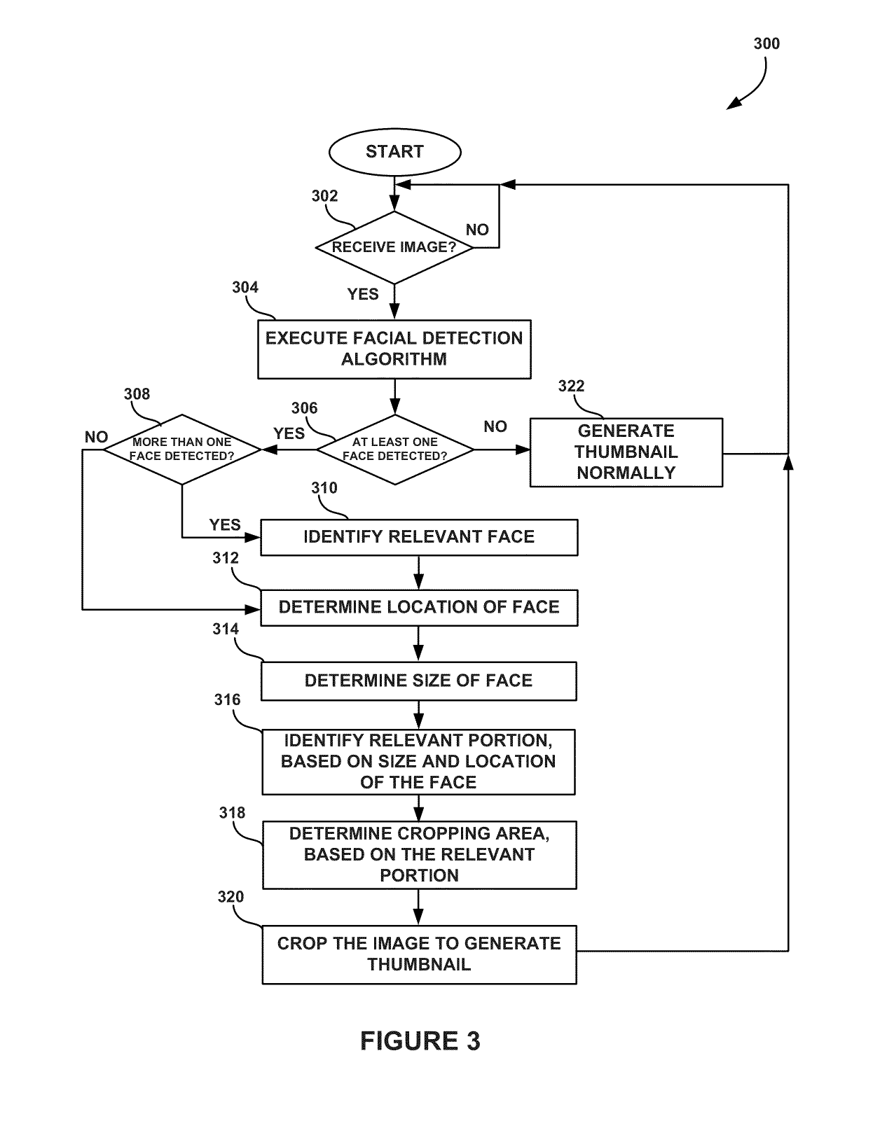

FIG. 3 shows a method 300 for generating an image thumbnail, in accordance with another embodiment. As an option, the method 300 may be implemented in the context of the functionality and architecture of the previous Figures and/or any subsequent Figure(s). Of course, however, the method 300 may be carried out in any desired environment. It should also be noted that the aforementioned definitions may apply during the present description.

As shown, it is determined whether an image is received. See decision 302. In one embodiment, the image may be received by a device that is associated with capturing the image. For example, in various embodiments, the image may be received by a camera, a mobile phone, a handheld device, a gaming device, a PDA, a tablet, a computer, a television, components thereof, and/or any other device. In another embodiment, the image may be received by device that is associated with receiving the image as a message (e.g. an MMS message, an email, etc.) or a download, etc.

If it is determined that an image has been received, a facial detection algorithm is executed. See operation 304. Further, it is determined whether at least one face is detected in the image. See operation 306.

If at least one face is not detected in the image, a thumbnail of the image is generated in a standard manner. See operation 322. In various embodiments, generating a thumbnail in a standard manner may include cropping the image based on a center portion of the image, cropping a top or bottom of the image, or cropping one or both sides of the image, etc.

If at least one face is detected in the image, it is determined whether more than one face is detected in the image. See decision 308. If more than one face is detected in the image, in one embodiment, a most relevant face is identified. See operation 310. In another embodiment, multiple faces may be determined to be relevant.

In various embodiments, the most relevant face in an image may include the largest face in an image (e.g. relative to other faces in the image, etc.), a face located closest to a center point of the image, a face that takes up the most surface area of the image (e.g. a face that was more directly aligned with a camera capturing the image, etc.), a combination of these qualities, and/or any other face that is determined to be the most relevant in the image.

Further, a location of the face is determined. See operation 312. In the case that multiple faces were detected, the location of the most relevant face or faces is determined. In the case that only one face was detected, the location of that face is determined. Additionally, a size of the face or faces is determined. See operation 314. In various embodiments, the location and/or size of the face may be determined in coordinate space (e.g. [x,y] coordinate space, etc.) or pixel space, etc.

Based on the determined size and location of the face or faces, a relevant portion of the image is identified. See operation 316. In one embodiment, the relevant portion of the image may include the face. In another embodiment, the relevant portion of the image may include the face and an area around the face (e.g. a border, a perimeter, etc.). In another embodiment, the relevant portion of the image may include multiple faces. For example, in one embodiment, the relevant portion of the image may be identified to include the multiple faces.

Further, a cropping area (e.g. a cropping rectangle, etc.) is determined based on the relevant portion. See operation 318. In one embodiment, the cropping area may include an area that includes the relevant portion (e.g. the face, multiple faces, etc.) and an area around the relevant portion. For example, in one embodiment, the relevant portion may include a square or rectangular area around the face (or faces) and the cropping area may be determined to be a square or rectangular area around the relevant portion.

In one embodiment, cropping area may be a scaled version of the relevant portion. For example, in one embodiment, the relevant portion may include a square or rectangle that is X units wide and Y units long (where Y may be equal to or greater than X, etc.). In this case, as an example, the cropping area may be determined to be a square or rectangle that is 2X units wide and 2Y units long (e.g. centered over the relevant portion, offset over the relevant portion, etc.). Of course, in various embodiments, the relevant portion and the cropping area may be any shape and/or size.

Once the cropping area is determined, the image is cropped based on the cropping area and an image thumbnail is generated for the image. See operation 320. In this case, the area of the image outside of the cropping area is cropped and the area inside the cropping area, including the relevant portion, is used as the thumbnail.

In one embodiment, the method 300 may be implemented when an image is captured. In another embodiment, the method 300 may be implemented when an image is saved. In another embodiment, the method 300 may be implemented when an image is received. Further, in one embodiment, the method 300 may be implemented once per image.

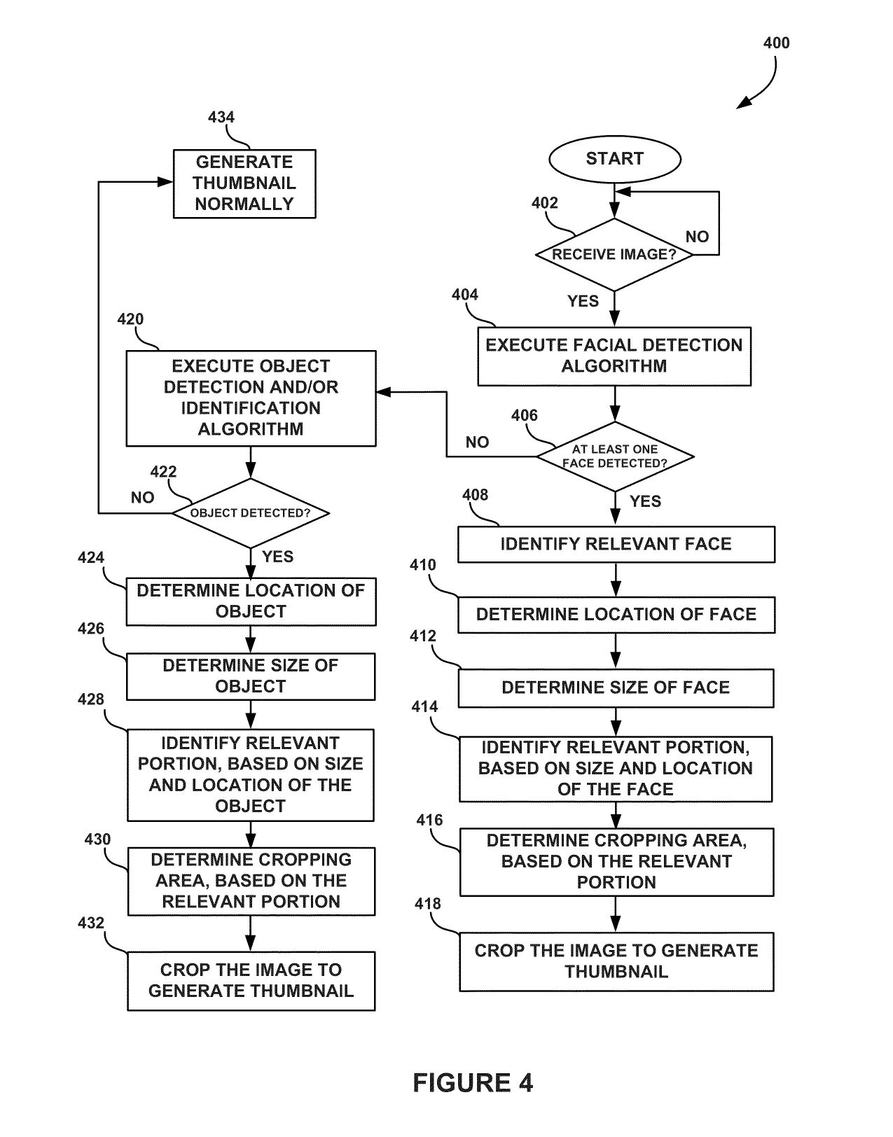

FIG. 4 shows a method 400 for generating an image thumbnail, in accordance with another embodiment. As an option, the method 400 may be implemented in the context of the functionality and architecture of the previous Figures and/or any subsequent Figure(s). Of course, however, the method 400 may be carried out in any desired environment. It should also be noted that the aforementioned definitions may apply during the present description.

As shown, it is determined whether an image is received. See decision 402. In one embodiment, the image may be received by an apparatus that is associated with capturing the image. For example, in various embodiments, the image may be received by a camera, a mobile phone, a handheld device, a gaming device, a PDA, a computer, a television, components thereof, and/or any other device. In another embodiment, the image may be received by an apparatus that is associated with receiving the image as a message (e.g. an MMS message, an email, etc.) or a download, etc.

If it is determined that an image has been received, a facial detection algorithm is executed. See operation 404. Further, it is determined whether at least one face is detected in the image. See operation 406.

If at least one face is detected in the image, a most relevant face (or faces) is identified. See operation 408. In various embodiments, the most relevant face in an image may include the largest face in an image (e.g. relative to other faces in the image, etc.), a face located closest to a center point of the image, a face that takes up the most surface area of the image (e.g. a face that was more directly aligned with a camera capturing the image, etc.), a combination of these qualities, and/or any other face that is determined to be the most relevant in the image. If one face is detected in the image, the detected face is determined to be the most relevant face. Of course, in one embodiment, multiple faces may be determined to be relevant.

Further, a location of the face is determined. See operation 410. Additionally, a size of the face is determined. See operation 412.

Based on the determined size and location of the face (or faces), a relevant portion of the image is identified. See operation 414. In one embodiment, the relevant portion of the image may include the face (or faces). In another embodiment, the relevant portion of the image may include the face (or faces) and an area around the face(s) (e.g. a border, a perimeter, etc.).

Further, a cropping area (e.g. a cropping rectangle, etc.) is determined based on the relevant portion. See operation 416. In one embodiment, the cropping area may include an area that includes the relevant portion (e.g. the face, etc.) and an area around the relevant portion. For example, in one embodiment, the relevant portion may include a square or rectangular area around the face and the cropping area may be determined to be a square or rectangular area around the relevant portion.

In one embodiment, cropping area may be a scaled version of the relevant portion. For example, in one embodiment, the relevant portion may include a square or rectangle that is X units wide and Y units long (where Y may be equal to or greater than X, etc.). In this case, as an example, the cropping area may be determined to be a square or rectangle that is 4X units wide and 4Y units long (e.g. centered over the relevant portion, offset over the relevant portion, etc.). Of course, in various embodiments, the relevant portion and the cropping area may be any shape and/or size.

Once the cropping area is determined, the image is cropped based on the cropping area and an image thumbnail is generated for the image. See operation 418. In this case, the area of the image outside of the cropping area is cropped and the area inside the cropping area, including the relevant portion, is used as the thumbnail.

If it is determined that at least one face is not detected in the image, an object detection and/or identification algorithm is executed. See operation 420. Further, it is determined whether an object is detected. See operation 422. In one embodiment, it may be determined if an identifiable object is detected (e.g. based on a library of identified objects, etc.).

If an object is not detected (e.g. the image is a scenery image, etc.), a thumbnail is generated in a standard manner. See operation 434. If an object is detected, a location of the object is determined. See operation 424. Additionally, a size of the object is determined. See operation 426. In various embodiments, the location and/or size of the object may be determined in coordinate space (e.g. [x,y] coordinate space, etc.) or pixel space, etc.

Based on the determined size and location of the object, a relevant portion of the image is identified. See operation 428. In one embodiment, the relevant portion of the image may include the object. In another embodiment, the relevant portion of the image may include the object and an area around the face (e.g. a border, a perimeter, etc.).

Further, a cropping area (e.g. a cropping rectangle, etc.) is determined based on the relevant portion. See operation 430. In one embodiment, the cropping area may include an area that includes the relevant portion (e.g. the object, etc.) and an area around the relevant portion. For example, in one embodiment, the relevant portion may include a square or rectangular area around the object (e.g. so the object is at the extent of the square/rectangle, etc.) and the cropping area may be determined to be a square or rectangular area around the relevant portion.

In one embodiment, cropping area may be a scaled version of the relevant portion. For example, in one embodiment, the relevant portion may include a square or rectangle that is X units wide and Y units long (where Y may be equal to or greater than X, etc.). In this case, as an example, the cropping area may be determined to be a square or rectangle that is 3X units wide and 3Y units long (e.g. centered over the relevant portion, offset over the relevant portion, etc.). Of course, in various embodiments, the relevant portion and the cropping area may be any shape and/or size.

Once the cropping area is determined, the image is cropped based on the cropping area and an image thumbnail is generated for the image. See operation 432. In this case, the area of the image outside of the cropping area is cropped and the area inside the cropping area, including the relevant portion, is used as the thumbnail.

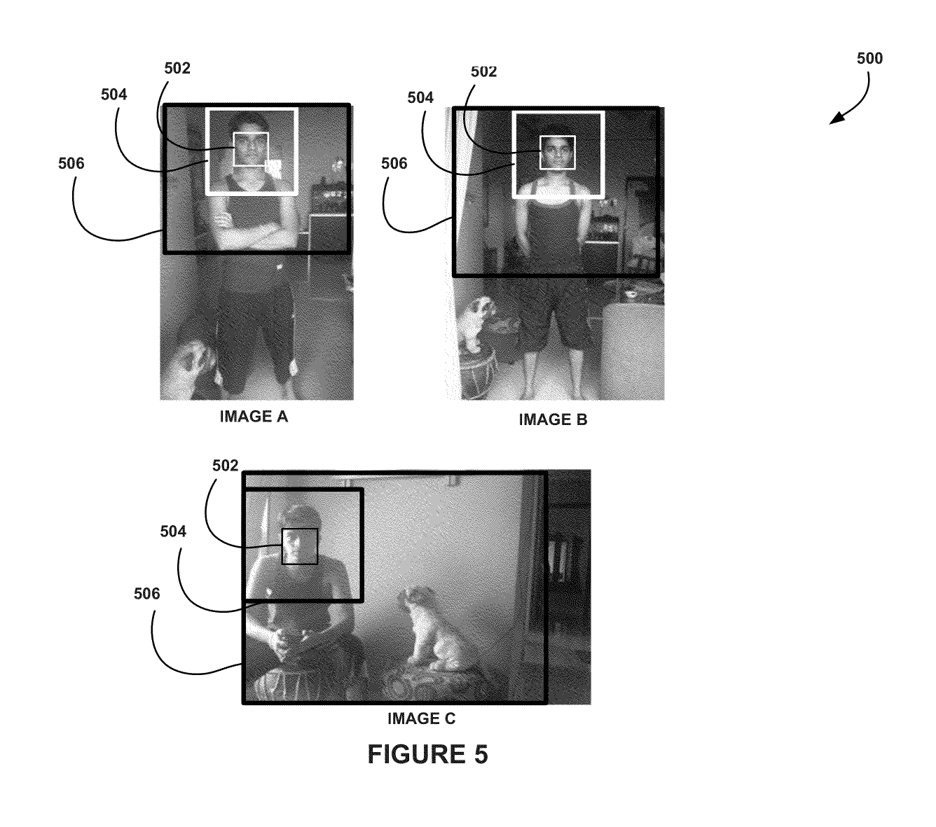

FIG. 5 shows a relevant portion determination of images 500, for use in generating an image thumbnail, in accordance with one embodiment. As an option, the relevant portion determination may be implemented in the context of the functionality and architecture of the previous Figures and/or any subsequent Figure(s). Of course, however, the relevant portion determination may be implemented in any desired environment. It should also be noted that the aforementioned definitions may apply during the present description.

As shown, a facial detection algorithm may be utilized to determine a face 502 and a most relevant portion 504 of an image. Further, a cropping area 506 may be identified, based on the most relevant portion 504 of the image. In one embodiment, the area of the images (e.g. Image A, Image B, and Image C) outside of the cropping area 506 may be cropped, such that the area inside of the cropping area 506 is utilized to generate a thumbnail for each of the images shown in FIG. 5.

Thumbnails of images are often used for displaying multiple images on a screen in applications associated with phones, tablets, and PCs, and also on web pages. The size of thumbnails is generally small to allow display of many images on a single screen. Application designers adopt different approaches to maximize the usability and experience of these small thumbnails.

For example, a first technique utilizes an equal-sized square region allotted to each thumbnail display and the complete image is “fit” to this screen. For JPEG images, a thumbnail from exchangeable image file format (exif) data may be displayed.

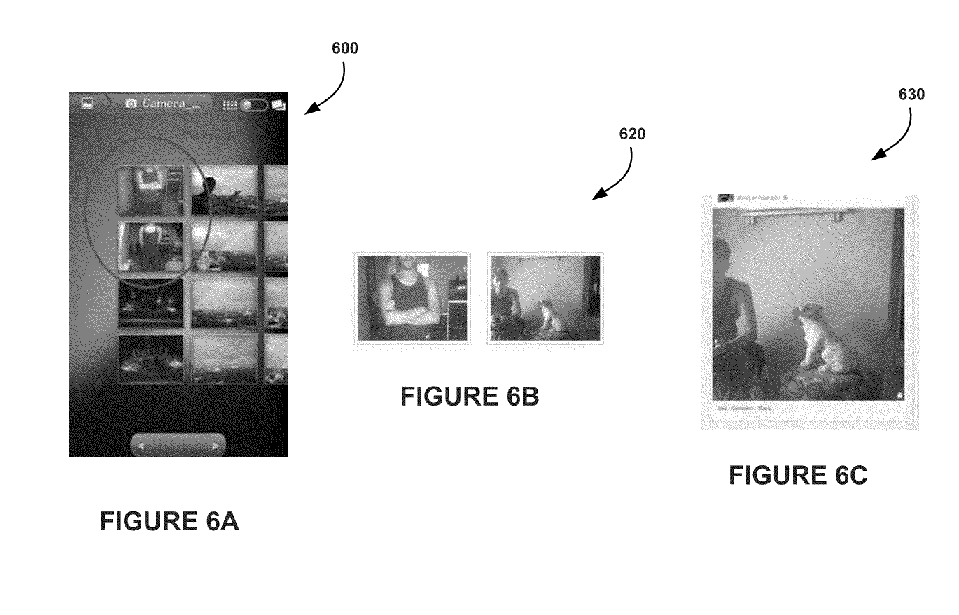

As a second technique, some smartphone gallery applications may allot an equal-sized rectangular region of a 4:3 aspect ratio for each thumbnail. In these cases, a maximum-sized 4:3 rectangular crop may be applied to the center of each image, and that may be displayed as the thumbnail. FIG. 6A shows an image 600 with a maximum-sized 4:3 rectangular crop applied to the center of Image A and Image B of FIG. 5.

As a third technique, some applications allow for a maximum-sized center crop of approximately a 5:4 ratio when displaying thumbnails in a photo application and a maximum-sized square (1:1) center crop when displaying images on a website. FIG. 6B shows an image 620 with a maximum-sized center crop of approximately a 5:4 ratio of Image A and Image C of FIG. 5. FIG. 6C shows an image 630 with a maximum-sized square (1:1) center crop of Image C of FIG. 5.

However, most images are not square. Hence, there is an empty space left in the square region when utilizing the first technique. Further, for images that have a large aspect ratio (e.g. 2:1 or 1:2), the thumbnail generated becomes quite small.

The second and third technique try to remedy this by displaying only a cropped version of the original image so that the thumbnail completely fills the area allotted for the thumbnail. This works when the aspect ratio of the original image is close to the thumbnail aspect ratio. The issue occurs when the aspect ratios are much different. For example, if an image is in portrait mode with aspect ratio of 3:4, when center-cropped to a 4:3 ratio, a significant portion of the top and bottom of the image is lost. When such a photo is of a standing person, the thumbnail is displayed with the head cut-off (e.g. as shown in FIG. 6A, etc.). Similar issues may occur when the original image is wider than the thumbnail and a person is on a side (e.g. as shown in FIG. 6C, etc.). This results in a bad viewing experience.

Accordingly, in one embodiment, when generating thumbnails of a size which involves cropping of the original image, a face-detection algorithm may be executed to determine the number, relative size, and location of faces in an image. In this way, the most important region in an image may be determined, as a face may be the most important part of the image. The cropping rectangle may be chosen to include this most important part of the image.

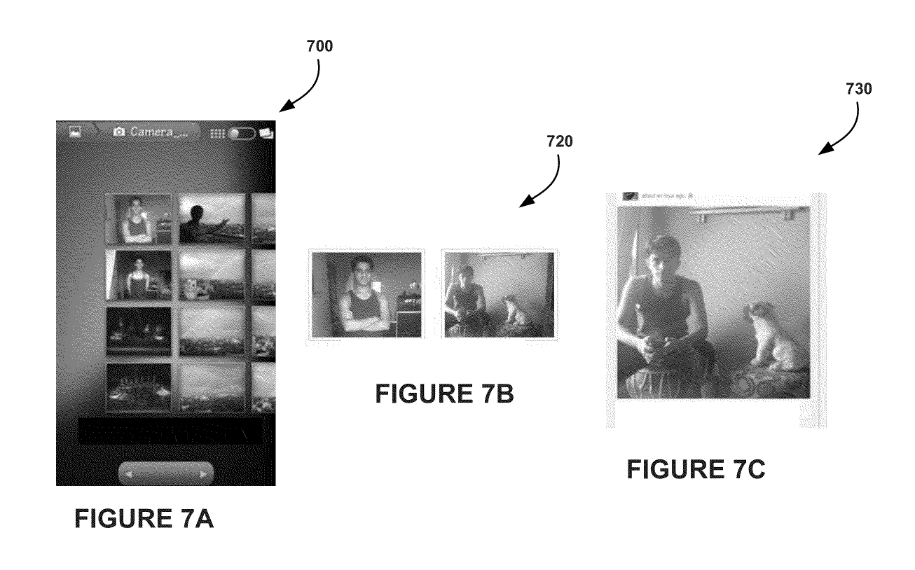

As an example, as shown in FIG. 5, squares may be utilized to represent the detected face 502 and the determined relevant portion 504 (i.e. the interesting region). In one embodiment, the relevant portion 504 may be centered on the face and may be approximately 3-4 times the size of face on each side. In one embodiment, the cropping rectangle 506 may be selected to be biased towards the center but to include the interesting region. FIGS. 7A-7C illustrate images 700, 720, and 730 showing exemplary results of applying the cropping rectangle 506 to the images of FIG. 5, in accordance with one embodiment.

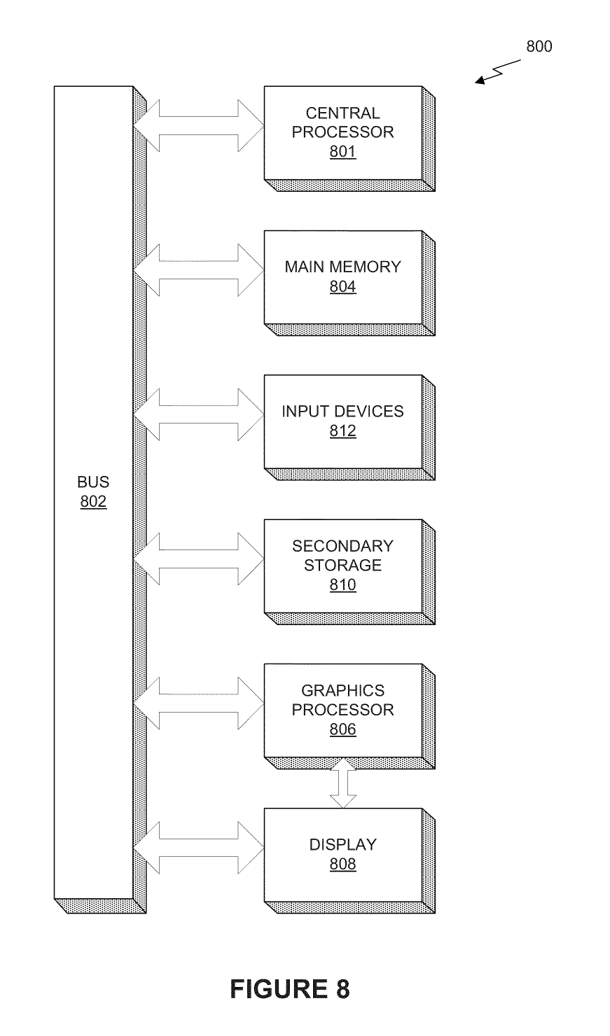

FIG. 8 illustrates an exemplary system 800 in which the various architecture and/or functionality of the various previous embodiments may be implemented. As shown, a system 800 is provided including at least one central processor 801 that is connected to a communication bus 802. The communication bus 802 may be implemented using any suitable protocol, such as PCI (Peripheral Component Interconnect), PCI-Express, AGP (Accelerated Graphics Port), HyperTransport, or any other bus or point-to-point communication protocol(s). The system 800 also includes a main memory 804. Control logic (software) and data are stored in the main memory 804 which may take the form of random access memory (RAM).

The system 800 also includes input devices 812, a graphics processor 806, and a display 808, i.e. a conventional CRT (cathode ray tube), LCD (liquid crystal display), LED (light emitting diode), plasma display or the like. User input may be received from the input devices 812, e.g., keyboard, mouse, touchpad, microphone, and the like. In one embodiment, the graphics processor 806 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. Computer programs, or computer control logic algorithms, may be stored in the main memory 804 and/or the secondary storage 810. Such computer programs, when executed, enable the system 800 to perform various functions. The main memory 804, the storage 810, and/or any other storage are possible examples of computer-readable media.

In one embodiment, the architecture and/or functionality of the various previous figures may be implemented in the context of the central processor 801, the graphics processor 806, an integrated circuit (not shown) that is capable of at least a portion of the capabilities of both the central processor 801 and the graphics processor 806, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 800 may take the form of a desktop computer, laptop computer, server, workstation, game consoles, embedded system, and/or any other type of logic. Still yet, the system 800 may take the form of various other devices including, but not limited to a personal digital assistant (PDA) device, a mobile phone device, a television, etc.

Further, while not shown, the system 800 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable storage medium storing instructions that, when executed by a processor, cause the processor to perform steps comprising:
receiving an image;
determining a most relevant portion of the image;
identifying a cropping area, based on the most relevant portion of the image;
applying the cropping area to the image; and
generating an image thumbnail for the image, based on the applied cropping area.

2. The computer-readable storage medium of claim 1, wherein determining the most relevant portion of the image includes identifying one or more faces present in the image.

3. The computer-readable storage medium of claim 2, wherein the steps further comprise determining a number of the one or more faces present in the image.

4. The computer-readable storage medium of claim 3, wherein, if it is determined that the number of the one or more faces present in the image is greater than one, the steps further comprise determining at least one most relevant face in the image.

5. The computer-readable storage medium of claim 4, wherein determining the at least one most relevant face in the image includes determining a largest sized face in the image.

6. The computer-readable storage medium of claim 4, wherein determining the at least one most relevant face in the image includes determining a centrally located face in the image.

7. The computer-readable storage medium of claim 3, wherein, if it is determined that the number of the one or more faces present in the image is greater than one, the steps further comprise determining a relevant region that includes multiple faces.

8. The computer-readable storage medium of claim 2, wherein the steps further comprise determining a size of the one or more faces present in the image.

9. The computer-readable storage medium of claim 8, wherein the cropping area is identified based on the size of the one or more faces present in the image.

10. The computer-readable storage medium of claim 2, wherein the steps further comprise determining a location of the one or more faces present in the image.

11. The computer-readable storage medium of claim 10, wherein the cropping area is identified based on the location of the one or more faces present in the image.

12. The computer-readable storage medium of claim 1, wherein the cropping area is identified as a region including the relevant portion of the image and biased towards a center point of the image.

13. The computer-readable storage medium of claim 1, wherein applying the cropping area to the image includes applying the cropping area centered on the determined most relevant portion of the image.

14. The computer-readable storage medium of claim 1, wherein applying the cropping area to the image includes applying the cropping area offset from a center of the determined most relevant portion of the image.

15. The computer-readable storage medium of claim 1, wherein applying the cropping area to the image includes cropping image data of the image that is located outside of the cropping area.

16. The computer-readable storage medium of claim 15, wherein generating the image thumbnail for the image includes utilizing the image data that is located inside the cropping area to generate the image thumbnail.

17. The computer-readable storage medium of claim 1, wherein determining the most relevant portion of the image includes utilizing a facial detection algorithm to detect a face present in the image.

18. The computer-readable storage medium of claim 1, wherein determining a most relevant portion of the image includes identifying one or more objects present in the image.

19. A sub-system, comprising:
a processor operable to receive an image, determine a most relevant portion of the image, identify a cropping area based on the most relevant portion of the image, apply the cropping area to the image, and generate an image thumbnail for the image based on the applied cropping area.

20. A method, comprising:
receiving an image;
determining a most relevant portion of the image;
identifying a cropping area, based on the most relevant portion of the image;
applying the cropping area to the image; and
generating an image thumbnail for the image, based on the applied cropping area.
